(19) United States
(12) Patent Application Publication
(10) Pub. No.: US 2015/0199680 A1
(43) Pub. Date: Jul. 16, 2015

(54) Global Unique Transaction Identifier (UTI) Generator

(71) Applicant: Framularo Group, LLC, Bridgeport, CT (US)

(72) Inventor: Nichole Framularo, Bridgeport, CT (US)

(73) Assignee: Framularo Group, LLC, Bridgeport, CT (US)

(21) Appl. No.: 14/156,425

(22) Filed: Jan. 15, 2014

(51) Int. Cl. G06Q 20/38

(52) U.S. Cl. CPC G06Q 20/38

(57) ABSTRACT

A Unique Transaction Identifier Generator (UTIG) is used to centralize and standardize the Unique Transaction Identifier (UTI) process by either (a) generating and creating, (b) assigning, (c) matching, (d) enriching or (e) distributing one or more unique identifier(s) for one or more transactions by and between one or more parties. The generator creates, assigns, matches, enriches and/or distributes one or more unique trade identifiers based on rules applied and is capable of using prefix, mathematics or simple linear count which will ensure the generation of unique data. This methodology allows the parties, their counterparts, third-party service providers and also internal hierarchy structures to maintain uniqueness.

U.S. Patent Documents

| | | |
|---|---|---|
| 2002/0087344 | July 2002 | Billings et al. |
| 2002/0120582 | August 2002 | Elston et al. |
| 2003/0200184 | October 2003 | Dominguez et al. |
| 2005/0119972 | June 2005 | Inglis |
| 2008/0052182 | February 2008 | Marshall |
| 2008/0059306 | March 2008 | Fordyce et al. |
| 2008/0133350 | June 2008 | White et al. |
| 2008/0300973 | December 2008 | DeWitt et al. |
| 2009/0112757 | April 2009 | Hammad et al. |
| 2009/0182654 | July 2009 | Mullen et al. |
| 2010/0169170 | July 2010 | Fordyce et al. |
| 2012/8219489 | July 2012 | Patterson |

Attorney, Agent or Firm: Framularo Group, LLC

### SUMMARY

The UTI is a transaction level identifier which is associated with a trade and persists throughout the entire life of that transaction. This process supports the Compliance reliability within but not limited to the Derivatives (OTC and ETD) markets. The UTI process enhances identification and mitigation of risk, harmonizes data, creates consistency and UTI generation and processing should take place at the earliest point in the lifecycle process of a trade. The UTIG is a solution to the industry encouraged by Regulatory Regimes and industry bodies, including but not limited to the CFTC, SEC, ESMA (EMIR/MiFID/MiFIR), HKMA, SFC, JFSA, MAS, FSB, SARB, National Treasury, CSA, FFSM, FSC, ASIC, RBI, CPSS-IOSCO et al to promote Unique Identifiers through a plethora of configurations and workflows. UTI configurations are necessary to meet the requirements of multiple regimes and their complex transaction identification, processing and reporting requirements. Workflows are continuously evolving as rules are finalized in many Regimes.

Various industries may benefit from the UTIG including but not limited to the financial services industry, commodity industry, telecommunications industry, and the healthcare industry.

Generator

The generator creates a unique trade number or identifier based on rules applied. The need is driven by a plurality of Regimes' specifications and maintaining uniqueness.

The generator is capable of using prefix, mathematics and or simple linear count. The UTIG system will ensure unique figures based on agreed configurations:
Linear
Prefix—Static Data
Prefix—Formula
UTI Body—Linear
UTI Body—Formula
Suffix—Linear
Suffix—Formula

The combinations will allow participants, their counterparts and also internal and external hierarchy structures to keep uniqueness, anonymity, and proprietary configurations on a continuous basis.

### DESCRIPTION OF THE DRAWINGS

Implementations will become more apparent from the detailed description set forth below when taken in conjunction with the drawings, in which like elements bear like reference numerals.

Each of the respective figures illustrate various states of UTI generation and processing. Namely, for (a) platform executed trades, (b) middleware affirmed trades, (c) centrally cleared transactions and (d) bilateral trades.

### DETAILED DESCRIPTION

FIG. 1 below illustrates where Party A (102) and Party B (104) execute a transaction within one or more trade execution or broker platforms. Each Party A (102) and B (104) enters into one or more transactions with known economics. The Execution Broker/Platform (103) will utilize the UTIG (101) to generate a Unique Identifier. Each Execution Platform (103) communicates to the UTIG (101), indicating the need for a UTI. The UTIG (101) will generate a UTI and communicate back to the execution broker (103) electronically. The Execution Broker then passes the UTI to both Parties A (102) & B (104). After both parties consume the UTI, they will augment the UTI with Reporting Data to one or more Trade Repositories (105).

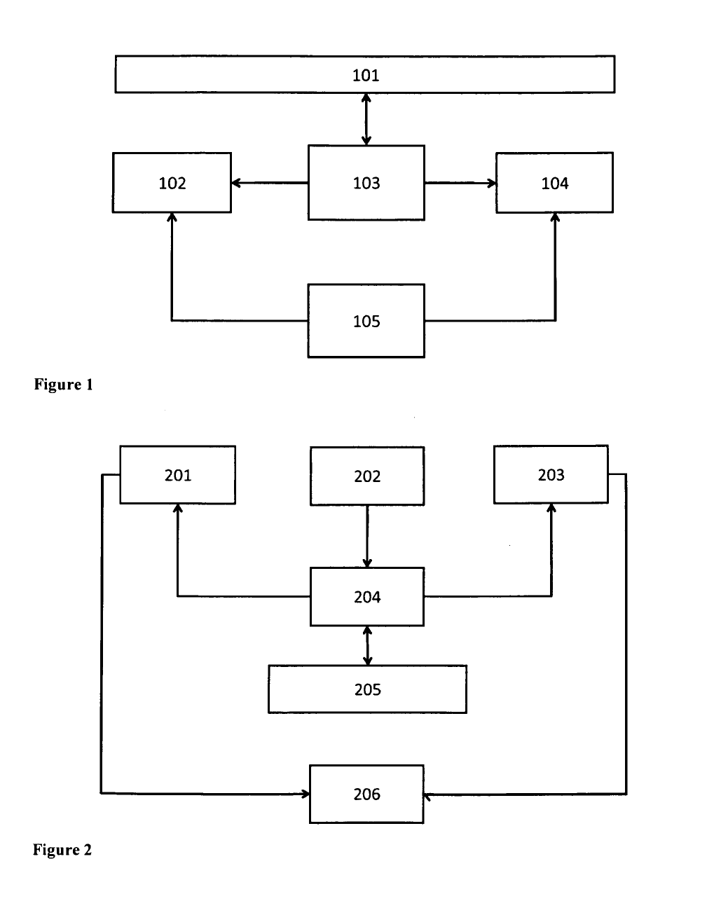

In FIG. 2 below Party A (201) and Party B (203) execute within the Broker Market (202). However, the Broker (202) communicates to the UTIG (205) with the Parties involved (201 & 203). The Middleware (204), being a functional utility within the Broker framework (202), communicates with the UTIG (205). The UTIG (205) creates a UTI, returns the UTI to the Middleware (204) and subsequently to both Parties A (201) and B (202). Both Party's A & B (201 & 202) are then obligated to Report to the Trade Repository (206).

In FIG. 3 below, both Parties A (302) and B (303) execute a transaction between one another directly. Two Parties can execute directly outside an electronic platform by using Instant Messaging, Voice or other means that result with an executed transaction. Regulatory Regimes have defined best practices and/or determinations as to who is responsible for providing a UTI. The Party responsible may register to the UTIG (301) and submit a request for one or more UTIs. The UTIG (301) will provide a UTI through various methods (Electronic, Logging into UTI, Email etc.). Through the submission, UTIG (301) may accept an ID and return the ID with an associated UTI. Users may find useful when transmitting through any means.

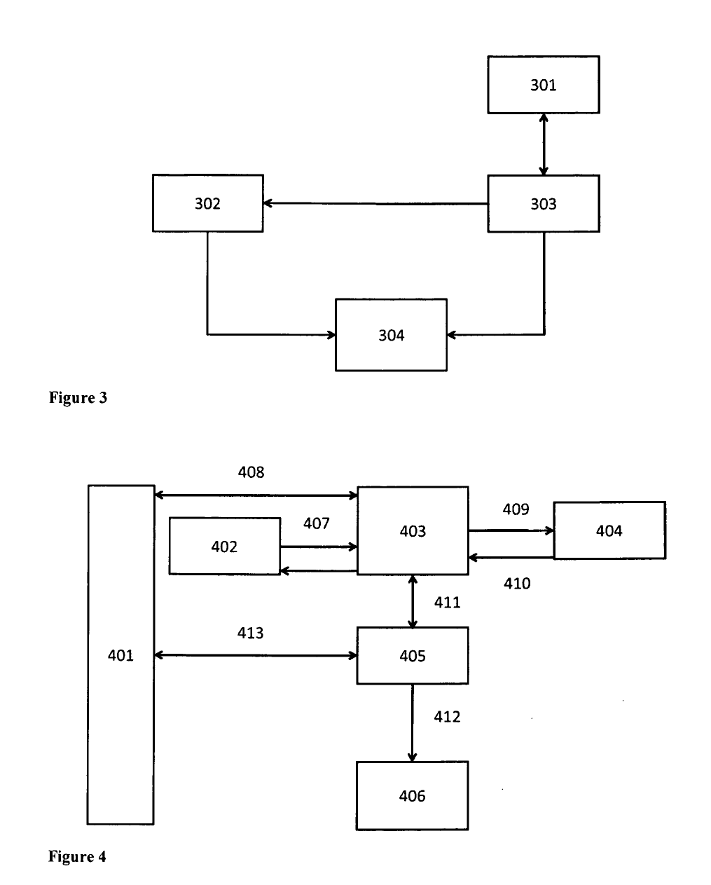

FIG. 4 illustrates where Party A (402) and Party B (404) execute a transaction (407 and 410, respectively) within the Broker platform (403). The Execution Broker (403) will utilize the UTIG (401) (Industry Solution) to generate a Unique Identifier. A request (408) from the Execution Platform (403) to the UTIG (401) communicates the need for a UTI. The UTIG (401) will create a UTI and acknowledge back to the execution broker (403) electronically. The Execution Broker (403) then provides the UTI to the exchange (405) to clear the transaction. The Exchange (405) recognizes the transaction as an Alpha Trade (408). This Alpha Transaction (408) is recognized as a bilateral trade and therefore requires the exchange (405) to send a cancel (411) for the Alpha (408) and create the Beta (407 and 413) and Gamma (409) submission. The Exchange (405) will then communicate the Beta (407 and 413)/Gamma (409) UTI to the Broker (403) and subsequently pass to Parties A (402) and B (404). After both parties (402 and 404) consume the UTI, they will augment the UTI with Reporting Data (412) to the Trade Repository (406).

What is claimed is:

1. A unique transaction identification generator comprising a processor and a non-transitory computer readable medium storing computer readable code capable of being executed by the processor to perform a method, the method comprising: (a) generating and creating, (b) receiving, (c) assigning, (d) matching, (e) enriching and/or (f) distributing one or more unique transaction identifier(s) for one or more transaction(s) by and between one or more parties, wherein the identification of a transaction is unique among the plurality of all transactions and all parties to the transaction(s); deriving a Unique Transaction Identifier (UTI), wherein each UTI in a plurality of UTIs is derived without using a corresponding identifier; associating, with the transaction, the UTI, wherein the UTI is unique within the processing system such that the UTI associated with the transaction is unique among the plurality of UTIs each associated with one transaction among the plurality of transactions conducted with the plurality of parties and each UTI in a plurality of UTIs is derived without using a corresponding account identifier of any account thereby ensuring anonymity.

2. The UTI generator of claim 1, the method further comprising a transmission to and/or from one or more parties, wherein the transmission formed or received includes the UTI.

3. The UTI generator of claim 1, the method further comprising a transmission to and/or from one or more parties, wherein the transmission formed or received includes each UTI in a plurality of UTIs derived without using a corresponding account identifier of any account thereby ensuring anonymity.

4. The UTI generator of claim 1, the method further comprising a transmission to and/or from one or more parties, wherein the transmission formed or received includes a UTI for one or more lifecycle events of a transaction including but not limited to new transactions, partial terminations, novations, terminations, corporate actions, exercises, et al.

5. The UTI generator of claim 1, wherein the UTI is derived using a unique prefix, a parameter of the transaction, a geographical indicator, a random or sequential identifier, or any combination thereof, without the identifier of one or more accounts.

6. The UTI generator of claim 1, the method further comprising: receiving a UTI generation request from one or more parties, wherein the request is formed in a separate transmission including one party's UTI, wherein the UTI is used to match the request with one or more codes for one or more transactions.

7. A method, using a processor, comprising: receiving a request having a code for one or more transactions between one or more parties, wherein the code of the transaction is unique among the plurality of transactions of one or more parties; deriving a Globally Unique Transaction Identifier (UTI), wherein each UTI in a plurality of UTIs is derived without using a corresponding account identifier of the account thereby ensuring anonymity; associating, with the transaction, the UTI, wherein the UTI is unique within one or more processing systems such that the UTI associated with the transaction is unique among the plurality of UTIs each associated with one transaction among the plurality of transactions conducted with the plurality of parties; forming one or more transmissions to one or more parties, wherein the transmission(s) include(s) the associated transaction and the relevant UTI; receiving either an assignment, matching or enrichment request from one or more parties, wherein the response includes the UTI; and receiving a request to assign, match and/or enrich one or more UTIs for one or more transactions for clearing and settling each respective transaction so that the final corresponding transaction can be forwarded to one or more parties, wherein the response includes the UTI.

8. The method of claim 7 further comprising receiving a transmission which includes a request to assign, match and / or enrich one or more UTIs for one or more transactions where one or more UTIs already exist for each corresponding transaction, available for both block transactions and their respective allocations.

9. The method of claim 7 further comprising receiving a transmission which includes a request to assign, match and/or enrich one or more UTIs for one or more transactions for clearing and settling each respective transaction so that the final corresponding transaction can be forwarded to one or more parties, wherein the transmission includes the UTI.

10. The method of claim 7, wherein the UTI is derived using a common identifier, a parameter of the transaction, a geographical indicator of one or more parties to the transaction, a random or sequential identifier, or any combination thereof.

11. The method of claim 7 further comprising receiving a request from one or more parties to one or more transactions, wherein the request is formed in a separate transmission including the UTI, wherein the UTI is used to match the request with the code for the transaction.

12. The method of claim 7, further comprising receiving a request from one or more parties to one or more transactions, wherein the request is formed in a separate transmission including one or more different UTIs for the same transaction or plurality of transactions, wherein the parties have the ability to determine which UTI becomes associated with and assigned to the respective transactions.

13. The method of claim 7, further comprising receiving a request from one or more parties to one or more transactions, wherein the request is formed in a separate transmission including one or more different UTIs for the same transaction or plurality of transactions, wherein UTIG has the ability to determine a) that the UTI is unique among all UTIs and b) which UTI becomes associated with and assigned to the respective transactions.
